(19) United States
(12) Patent Application Publication
(10) Pub. No.: US 2018/0158106 A1
(43) Pub. Date: Jun. 7, 2018

(54) METHOD FOR MANAGING INDOOR BEACON-BASED COMMUNICATION

(71) Applicant: Comarch SA, Krakow (PL)

(72) Inventor: Marcin WARWAS, Krakow (PL)

(73) Assignee: Comarch SA, Krakow (PL)

(21) Appl. No.: 15/883,833

(22) Filed: Jan. 30, 2018

Related U.S. Application Data
(63) Continuation of application No. 14/812,622, filed on Jul. 29, 2015.

(51) Int. Cl. G06Q 30/02; H04W 64/00; H04W 4/33; H04W 4/80

(52) U.S. Cl. CPC G06Q 30/0261; H04W 64/00; G06Q 30/0267; H04W 4/80; H04W 4/33

(57) ABSTRACT

A method for content distribution in an indoor space and surrounding area covered by beacon signals. The method includes setting general data of the content, setting at least one location in the indoor space, including one or a combination of active/inactive locations and other relevant information available in a system, assigning beacons that trigger the content in the indoor space, receiving by the system, from a portable device via a first communication channel, beacon information that is received from a beacon by the portable device via a second communication channel, the first communication channel being different from the second communication channel, setting a singular event or plural events which initiates the content in the indoor space, setting a condition formula for the content which must be fulfilled to qualify for the content, and setting singular or plural results of the content that are provided when the condition formula is fulfilled.

### CROSS-REFERENCE TO RELATED APPLICATION

This application is a continuation of application Ser. No. 14/812,622, filed in the United States Patent and Trademark Office on Jul. 29, 2015, the entire contents of which are incorporated herein by reference.

### BACKGROUND OF THE INVENTION

### Field of the Invention

The present disclosure relates to the field of indoor communication. More particularly, the present disclosure pertains to a method and system for managing various marketing content directed to a plurality of recipients based on Beacon proximity detection technology and its aspects.

### Description of Related Art

According to emerging trends, managing the communication with clients puts emphasis on the development of the area of Indoor Proximity Experience with the usage of clients' Portable Devices. Companies leading or going to lead precision marketing strategy indoor must focus on targeting clients indoors with dedicated content adjusted to their lifestyle, interests, position of mobile device and distance from items located indoors which clients should pay attention to.

In the current state of the art, companies predominantly provide their clients with mobile applications which, integrated with their Back-Office Systems, are able to receive tailored content fitted to location-based features of a client's mobile device. In practice, this happens thanks to GPS signal, Wi-Fi signal. However, the two mentioned wireless networking standards do not meet the existing demand for distributing tailored content indoors that precisely corresponds to clients' accurate positions, preferences and are not sufficient in managing precision marketing strategy indoors. GPS signal does not support the client's indoor activity and in effect makes such communication unattainable. Wi-Fi signal can reach even up to 100 m and potentially may hinder triggering communication indoor that should accurately target client's mobile device indoor with dedicated and specific content. In fact, Wi-Fi signal may reach clients with indoor communication which is neither relevant nor distinct and not adjusted to their expectations indoor.

Therefore, there exists a need in the art for a method able to eliminate current deficiencies in the technology by reaching clients with accurate and precise communication indoor based on effective proximity detection technology that uses a shorter signal range.

### BRIEF SUMMARY OF THE INVENTION

An embodiment of the present disclosure is directed to a method for managing location-based incentives indoor relying on Beacon proximity detection technology that works indoors and on Bluetooth signal as a newer wireless local networking standard with its shorter range up to 10-15 m. Thus, an Indoor Proximity Experience can be made effective when recipients are in an Indoor Space. The method allowing tracking of the recipients indoor activity, using the communication between a Dedicated Application installed on a Portable Device and the Beacons installed in an Indoor Space. The knowledge about recipients indoor activity is crucial in modern marketing strategies.

Beacon supports passive (listener) and active (broadcaster) actions allowing Business Entities to gain better insights into traffic in their Indoor Space e.g. restaurants, coffee shops, hotels, airports, etc. Thus, the Business Entities can target recipients indoors with contextually relevant content.

More precisely, Beacon is a micro-location technology that uses Bluetooth Low Energy (BLE) signal. It periodically sends data packets that can be received by any Portable Device (e.g. smartphone, tablet, notebook, smartwatch, etc.) to communicate its presence to those recipients who are within the range of the Beacon signal. This makes Beacon proximity technology appropriate wireless networking standard to answer the need for boosting the Indoor Proximity Experience by targeting specific recipients' locations and expectations. In consequence, the embodiments of the present disclosure allow recipients not to be burdened with indoor communication irrelevant for them.

One exemplary embodiment of the present disclosure includes creation of the location-based incentives that target recipients with the use of Beacon proximity detection technology in the Indoor Space and the surrounding area covered by Beacon signals. In this aspect of the disclosure, creation of the location-based incentives in the Back-Office System may comprise configuration of:
a) general data of the location-based incentives e.g. date of its execution (start/end date), active hours, fixed schedule, its description,
b) location(s) in the Indoor Space of the involved Business Entities such as active/inactive locations and other relevant information available in the Back-Office System,
c) Beacons which may trigger the location-based incentives in the Indoor Space,
d) Determinants of the location-based incentives that is singular or plural events which may initiate the location-based incentives in the Indoor Space, i.e. a purchase, non-purchase event, a coupon, etc.
e) Target Group eligible to receive and participate in the location-based incentives,
f) Condition Formula which must be fulfilled to run Results of the location-based incentives, that is a mathematical expression determining whether the Results of location-based incentives are applied,
g) singular or plural Results of the location-based incentives including: benefits, privileges, given when the condition formula of the location-based incentives is fulfilled.

With no further limitation, many variations of the location-based incentives (e.g. messages, adverts, surveys, gamification events, quizzes, offers, statements, other) may be pushed to the recipients at the time when the Dedicated Application installed on the Portable Device detects Beacons in the Indoor Space. The location-based incentives may also be configured as to their number, priority, time intervals, expiry time, proximity to Beacons required to receive them, alert, permission requirements.

In one embodiment there is provided a method for location-based incentives targeting an indoor space and surrounding area covered by beacon signals, the method includes setting general data of the location-based incentives. At least one location is set in the indoor space of a business entity, including one or a combination of active/inactive locations and other relevant information available in a back-office system. Beacons are assigned that trigger the location-based incentives in the indoor space. A singular event or plural events is set which initiates the location-based incentives in the indoor space. A target group is set that is eligible to receive and participate in the location-based incentives. A condition formula is set for the location-based incentives which must be fulfilled to qualify for the location-based incentives. A singular or plural results of the location is set-based incentives that are provided when the condition formula of the location-based incentives is fulfilled, the singular or plural results including benefits and/or privileges. Recipients' preferences are determined before or during a recipient's presence in the indoor space, including indoor and outdoor: purchase and/or non-purchase activity, attributes, interests, location-based data, passed-by items and/or checkpoints. At least one of the location-based incentives is selected, by circuitry of the back-office system, based on one or a combination of the set general data of the location-based incentives, the set at least one location in the indoor space, the assigned beacons that trigger the location-based incentives, the set condition formula, the set singular or plural results, and the determined recipients' preferences. The method further includes transmitting, by the circuitry, the selected at least one of the location-based incentives to a portable device.

The method may also include the assignment of Beacons categories to location-based incentives, so that there is no need to assign location-based incentives to many individual Beacons from different locations of the Indoor Space because replicable scenarios may be applied.

The method may also include gathering and processing information about Beacons installed in the Indoor Space which may be used e.g. to prepare reports on the effectiveness of recipients' activity indoor and to monitor, analyze their buying decisions.

Another exemplary embodiment of the present disclosure includes dissemination of the location-based incentives to recipients with the use of Beacon proximity detection technology in the Indoor Space and the surrounding area covered by Beacon signals. In this aspect of the disclosure, dissemination of the location-based incentives requires:
a) communication between a recipient's Portable Device in the Indoor Space and secured Beacon devices installed in the Indoor Space,
b) the Dedicated Application, installed on the Portable Device, responding to beacon signal by prompting the dedicated location-based incentives on recipient's Portable Device,
c) the Dedicated Application integrated with a Back-Office System,
d) the Portable Device with Bluetooth signal turned on,
e) the recipient with the Portable Device being in the Indoor Space and receiving location-based incentives,
f) Beacon devices with their UUID installed in the Indoor Space transmitting signals to a recipient's Portable Device,
g) the Back-Office System communicated with Sales Systems installed at the premises of Business Entities who manage precision marketing strategy in/outdoor,
h) Location-based incentives with pre-build Marketing Guidelines delivered by Business Entities,
i) the Back-Office System in which location-based incentives are created, stored and further processed, comprising: a Database, a Data Analytics Engine, a Rule Engine, Target Groups, the Onsite Back-End Application.

Depending on whether the Dedicated Application is connected to the Back-Office System, the subsequent distribution of the location-based incentives to recipients may be executed in two scenarios: 1) online, when real-time location-based incentives are synchronized after log in to the Dedicated Application or 2) offline, when the Dedicated Application displays cached location-based incentives downloaded earlier. Location-based incentives are triggered at the time when a Dedicated Application detects Beacons proximity in the Indoor Space. Based on Beacons, the Dedicated Application can search for a given Beacon signal pattern, locate a recipient in the Indoor Space and apply miscellaneous location-based incentives near the Beacon of a given category. Only nearby location-based incentives are displayed on the Portable Device, as the Dedicated Application is configured to listen only to Beacon with its particular proximity UUID.

In one embodiment, there is provided a method of a system for disseminating location-based incentives, in an indoor space and a surrounding area covered by beacon signals, the method includes transmitting, by beacons, beacon signals to a dedicated application and reading, by circuitry of a portable device with a Bluetooth function turned on and the dedicated application installed on the portable device, the beacon signals. The method further includes communicating with circuitry of a back-office system by the dedicated application, such that: the dedicated application, even when not turned on and without a connection to the back-office system, displays all notifications, including cached location-based incentives, which were downloaded earlier from the back-office system and are stored locally on the portable device, sends all offline beacon events to the back-office system for evaluation and application of rules for offline beacon events after the connection to the back-office system is restored, the offline beacon events being triggerable by any set of detected beacons so that singular or plural results can be applied, or the dedicated application, even when not turned on and with the connection to the back-office system, displays all local push notifications including location-based incentives. The method includes sending to the back-office system all detected beacons parameters to prepare in a rule engine online beacon events, and evaluating the online beacon events in the rule engine and applying rules for the online beacon events, which are triggerable by any set of the detected beacons so that the singular or plural results can be applied. Any of the location-based incentives is prepared in the rule engine that match a recipient's preferences, target group, and/or beacons and the matched location-based incentives are sent back to the dedicated application of the recipient. The method further includes receiving a selection of one or more of the location-based incentives from the recipient of the dedicated application, and displaying details of the selected one or more of the location-based incentives by the dedicated application.

The method may also include identifying recipients equipped with Portable Devices and Dedicated Application visiting the Indoor Space by displaying in the Onsite Back-End Application a list of relevant recipients' data for quick preview. This aspect of the method allows to e.g. track their presence and analyze their activity and movement within the Indoor Space and to provide personal and tailored service and assistance within the Indoor Space that match e.g. their Preferences.

### BRIEF DESCRIPTION OF THE DRAWING

Miscellaneous embodiments of the present disclosure taught herein are illustrated by way of example, and not by way of limitation, in the FIG. s of the accompanying drawings, in which:

FIG. 1 shows a functional diagram of the method for managing location-based incentives in the Indoor Space in accordance with an embodiment of the present disclosure.

FIG. 2 shows an example of targeting recipient's Portable Device with the location-based incentives in the Indoor Space in accordance with an embodiment of the present disclosure.

FIG. 3 is a diagram showing an example of the location-based incentive displayed on the Portable Device in accordance with an embodiment of the present disclosure.

FIG. 4 is a diagram showing an example of identifying the recipient entering the Indoor Space in accordance with an embodiment of the present disclosure.

FIG. 5 is a diagram showing an example of defining location-based incentives triggered by Beacons in accordance with an embodiment of the present disclosure.

FIG. 6 is a diagram showing an example of assigning Beacons with the location-based incentives to the Indoor Space in accordance with an embodiment of the present disclosure.

FIG. 7 shows a flow diagram illustrating a method for disseminating location-based incentives in the Indoor Space relying on Beacon proximity detection technology in accordance with an embodiment of the present disclosure.

FIG. 8 is a block diagram showing an example of a hardware configuration of a computer.

### DETAILED DESCRIPTION OF THE INVENTION

The present disclosure will be described in detail by way of example with reference to the attached drawings. The present disclosure is to be considered as an example of the principles of the invention and not intended to limit the invention to the specific embodiments and examples shown and described. As used herein, the “present invention” refers to any one of the embodiments of the invention described herein, and any equivalents. While the “present invention” has been described in connection with the illustrated embodiments, it will be appreciated and understood that modifications may be made without departing from the true spirit and scope of the invention.

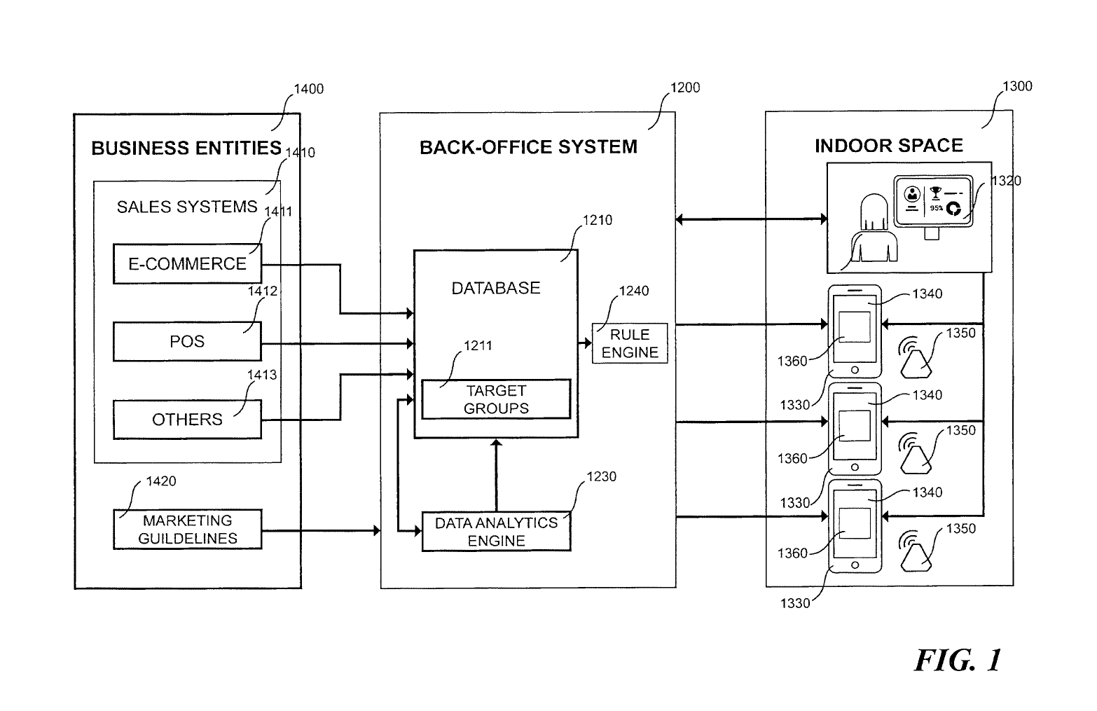

Referring now to the present disclosure in more detail, in FIG. 1 there is shown a functional diagram of a method for managing the location-based incentives 1360 within the Indoor Space 1300 comprising recipient's Portable Device 1330, equipped with the Dedicated Application 1340 integrated with the Back-Office System 1200 linked with the Sales System 1410, and Beacons 1350 installed in the Indoor Space 1300.

In more detail, still referring to FIG. 1, the Sales System 1410 installed at the premises of Business Entities 1400 may be, with no further limitation, represented by, e.g. POS 1412, E-commerce 1411, and Other sources 1413. A variety of different methods, including online and/or off-line, may be used to by the Sales System 1410 to communicate with the Back-Office System 1200. Business Entities 1400, pre-defining Marketing Guidelines 1420, may comprise any singular or plural body leading or going to lead precision marketing strategies in the Indoor Space 1300 to the specific group of recipients. A recipient is every person receiving or potentially being able to receive the location-based incentives on the Portable Device, including, but not limited to: Business Entities' clients, their prospective clients, partners, in every relation and combination such as: B2C, B2B, B2E, others.

In further detail, still referring to FIG. 1, all actions in the Back-Office System 1200 may be results of internal or external events and the Back-Office System 1200 may comprise:
the Database 1210 storing and processing unlimited data, e.g. to determine recipients' Preferences which are further used to create location-based incentives;
the Data Analytics Engine 1230 to perform data mining, forecasts, predictions of recipients' activity and to build Target Groups 1211;
the Rule Engine 1240 preparing location-based incentives pushed to recipient's Portable Device 1340 that target Indoor Space 1300;
the Target Groups 1211 to create precise group of recipients with the common characteristics, which then may be assigned to location-based incentives.

Recipients' Preferences, which are needed to create tailored and personalized location-based incentives, may be determined based on data coming from internal (e.g. the Back-Office System 1200) as well as external (e.g. Business Entities 1400) sources and pertaining to recipients, including but not limited to in and outdoor: purchase and/or non-purchase activity, attributes, interests, location-based data, passed-by items or checkpoints. Moreover, Preferences are either predetermined beforehand or they are determined in real-time, that is during recipient's presence in the Indoor Space 1300.

In further detail, still referring to FIG. 1, the Back-Office System 1200 allows also for bi-directional data exchange. Target Groups 1211 may alternatively be configured internally in the Back-Office System 1200 as a background process or imported to the Back-Office System 1200 from external sources: e.g. given by the Business Entities 1400 or others. Target Groups 1211 may also be exported from the Back-Office System 1200. The Target Groups 1211 may be refreshed manually or automatically on a scheduled date in the Back-Office System 1200.

When created internally, Target Groups 1211 may include configuration of:
similar specific recipients' attributes in the Data Analytics Engine 1230, including but not limited to: Preferences, age, gender, etc.;
qualifying rules in the Rule Engine 1240 that may depend on recipients' activity including but not limited to: money spent over a period of time, number of check-ins in particular locations of the Indoor Space 1300 with specific Beacons 1350 to automatically include or exclude recipients from particular group without the involvement of Data Analytics Engine 1230; and/or
creation of Target Group 1211 does not have to include any of the two ways described above and may simply include defining a specific group of recipients selected by reference to one or many selected criteria.

In further detail, still referring to FIG. 1, the Back-Office System 1200 allows for setting limits on the number of location-based incentives 1360 which one recipient can get at one location of the Indoor Space 1300. All location-based incentives 1360 sent to the recipients are also stored in the Back-Office System 1200.

In further detail, still referring to FIG. 1, the Indoor Space 1300 in which Business Entities 1400 conduct precision marketing strategy is marked out by Beacons installed in its singular or multiple locations. The Indoor Space 1300 as well as the surrounding area are covered by Beacon signals. The Indoor Space 1300 may exist in various scenarios:
a) may be operated by one or more Business Entities,
b) as different locations of one/multiple Business Entity/ies.

The Indoor Space 1300 should be equipped with Beacons 1350 to communicate with the recipient's Portable Device 1330 with Bluetooth turned on and the Dedicated Application 1340 installed on the Portable Device 1330. Providing tailored support, enabled by information about recipients' presence and activity in the Indoor Space 1300, by an Indoor Space Assistant 1310, may also require installing the Onsite Back-End Application 1320 in the Indoor Space 1300.

Still referring to FIG. 1, information about Beacons 1350 installed in the Indoor Space 1300 may also be used to track recipients buying decisions to conduct further predictions in the Data Analytics Engine 1230. For instance, it is possible to prepare detailed reports on the effectiveness of the location-based incentives 1360 using Beacons' information of how many recipients from a given Target Group 1211 were in the Indoor Space 1300 where the Beacons 1350 are installed.

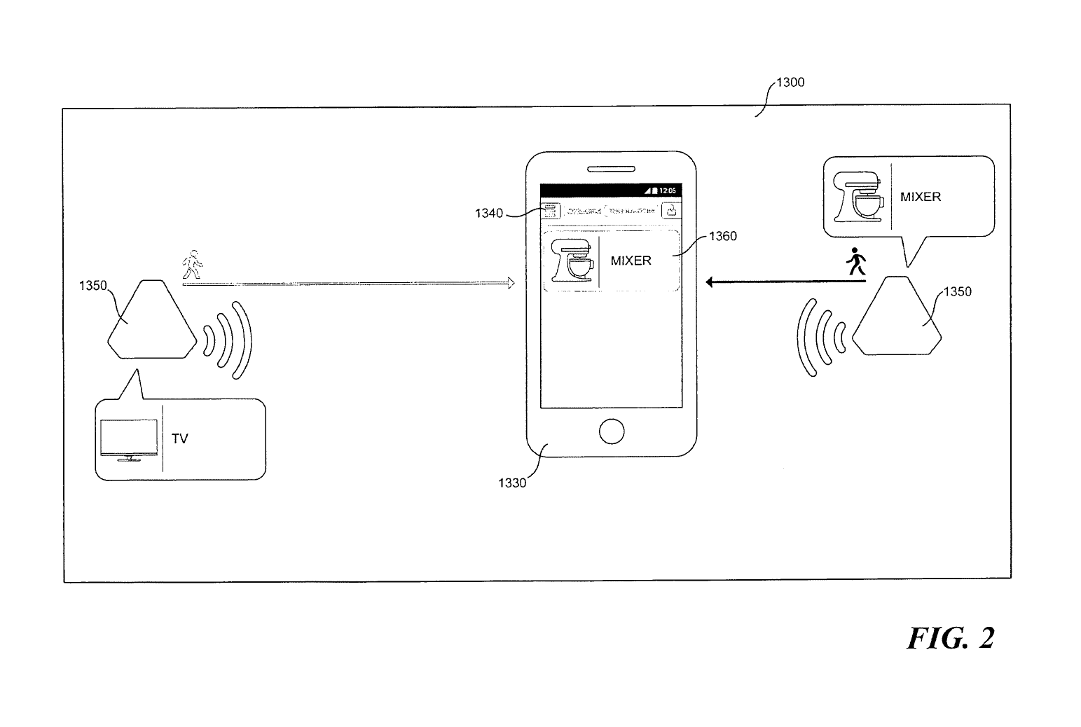

FIG. 2 shows an example of targeting the recipient's Portable Device 1330 with the location-based incentives 1360 in the Indoor Space 1300 employing Beacons 1350 installed in it. When the recipient downloads and installs on his/her Portable Device 1330 the Dedicated Application 1340, he/she is asked to accept notifications from it. If it is accepted, the provider token (e.g. Android, IOS) is stored in the Back-Office System 1200. The recipient may indicate on a map the specific locations nearby his/her position. Hence, it is advisable that the Portable Device 1330 is able to read GPS signal and Google Maps.

In more detail, still referring to FIG. 2 the Dedicated Application 1340 awaits a given Beacon 1350 signal pattern to locate a recipient in the Indoor Space 1300 and display location-based incentives 1360 pushed by the Back-Office System 1200 that target the Indoor Space 1300 even while the Dedicated Application 1340 is running in the background. While the recipient moves in the Indoor Space 1300, the Dedicated Application 1340 awaits notifications. Details of location-based incentives 1360 are shown on the first screen right after starting the Dedicated Application 1340. The Back-Office System 1200 allows a business entity, for example, to specify how close to Beacons 1350 the recipient must be to receive the location-based incentives 1360, and to specify also how many times one recipient can get the same location-based incentives within a specified time interval.

Still referring to FIG. 2, there may be many Beacons 1350 installed in the Indoor Space 1300 that may trigger various location-based incentives 1360 near the Beacon of given category. Beacon category assignment takes place in the Back-Office System 1200 and is used in the Rule Engine 1240 while creating the location-based incentives 1360. Only nearby location-based incentives 1360 are displayed on the recipient's Portable Device 1330, as what distinguishes Beacon signal from others is that the Dedicated Application 1340 is configured to listen only to the Beacon with its particular proximity QUID:
Immediate,
Near,
Far.

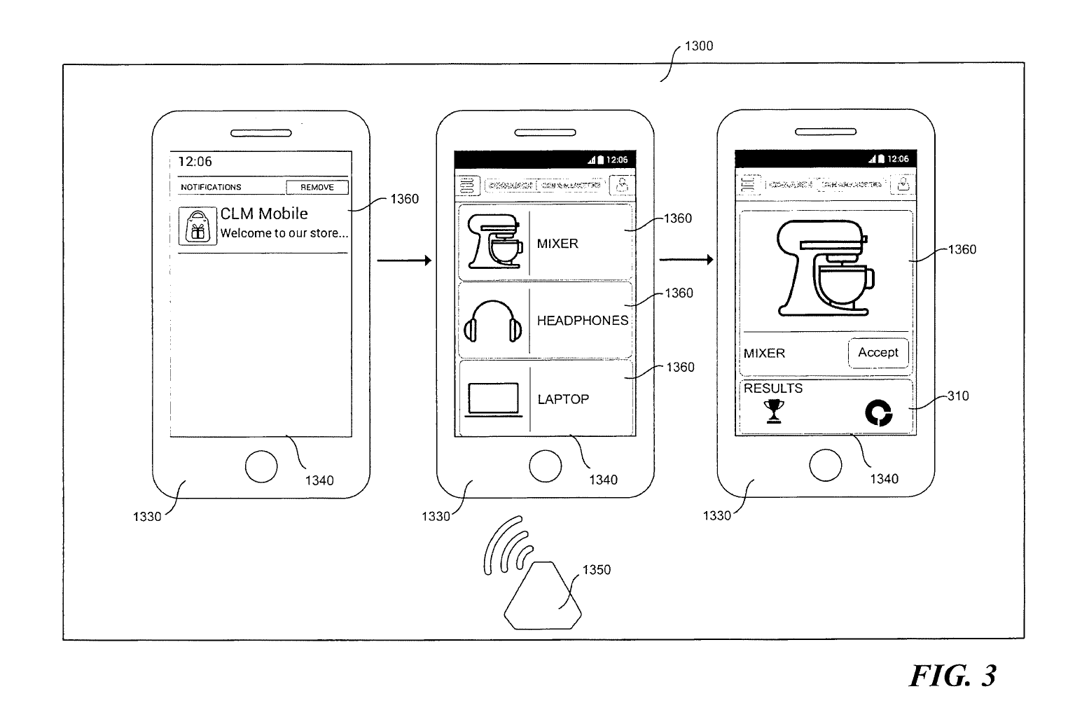

FIG. 3 illustrates an example of the location-based incentive 1360 when the Dedicated Application 1340 installed on recipient's Portable Device 1330 detects Beacon 1350. The Portable Device 1330 responds to the signal from Beacons 1350 installed in the Indoor Space 1300 only when three conditions are simultaneously met: Bluetooth on this Portable Device 1330 is turned on, the Dedicated Application 1340 which responds to a specific Beacon 1350 data packet has been downloaded and installed on this Portable Device 1330 and the recipient is in the area of Beacons 1350. Then, the Portable Device 1330 gets the notifications, including the location-based incentives 1360 associated with Beacons 1350 matching also the recipient Preferences, and his/her assigned group of recipients with common characteristics.

In more detail, still referring to FIG. 3, with no further limitation the location-based incentives 1360, sent to the recipients at the time when the Dedicated Application 1340 installed on the Portable Device 1330 detects Beacons 1350 in the Indoor Space 1300, may be various, including: messages, adverts, surveys, statements, marketing offers, gamification events, quizzes, others.

In particular, the exemplary variations of the location-based incentives 1360 may comprise:
a) a “check-in message” in the Indoor Space 1300,
b) a reminder for an accomplishment of a specific task (a gamification element) e.g. “please, visit all textile departments in our store, and earn extra loyalty currency”,
c) a message, e.g. recipient's proximity to Beacon 1350 installed at the entrance to the Indoor Space 1300 can trigger e.g. possibility of obtaining some extra discounts at a later stage,
d) an offer to purchase specific product(s), service(s) or both, to get Results 310 related to it.

The location-based incentives 1360 may include additional conditions the recipient should meet in order to get singular or plural Results 310 related to the location-based incentives 1360. The Results 310 may be defined as any kind of benefits, privileges assigned to the location-based incentives 1360 (e.g. points, a discount, a message, a voucher, a coupon, a free product/service, etc.), including:
a) rewarding the recipient just for visiting the Indoor Space 1300 as the communication with the recipient may not always be aimed at forcing them to purchase,
b) rewarding the recipient for an accomplishment of a specific task in the Indoor Space 1300 using Beacons 1350, to gamify recipients being indoors.

The location-based incentives 1360 may also be displayed on the Portable Device 1330 with alerts and it is possible to define in a background process which location-based incentives 1360 should have them.

In more detail, still referring to FIG. 3, the recipient may also set what kind of the location-based incentives 1360 he/she would like to get in the Indoor Space 1300.

The Dedicated Application 1340 displays a list of all location-based incentives 1360 with filters, e.g. Business Entities A-Z, in a flat list, etc., so the recipient may narrow their view to see e.g.:
Unread,
Last Chance (ending in Y days),
Nearby (started in last X days),
New location-based incentives,
Accepted.

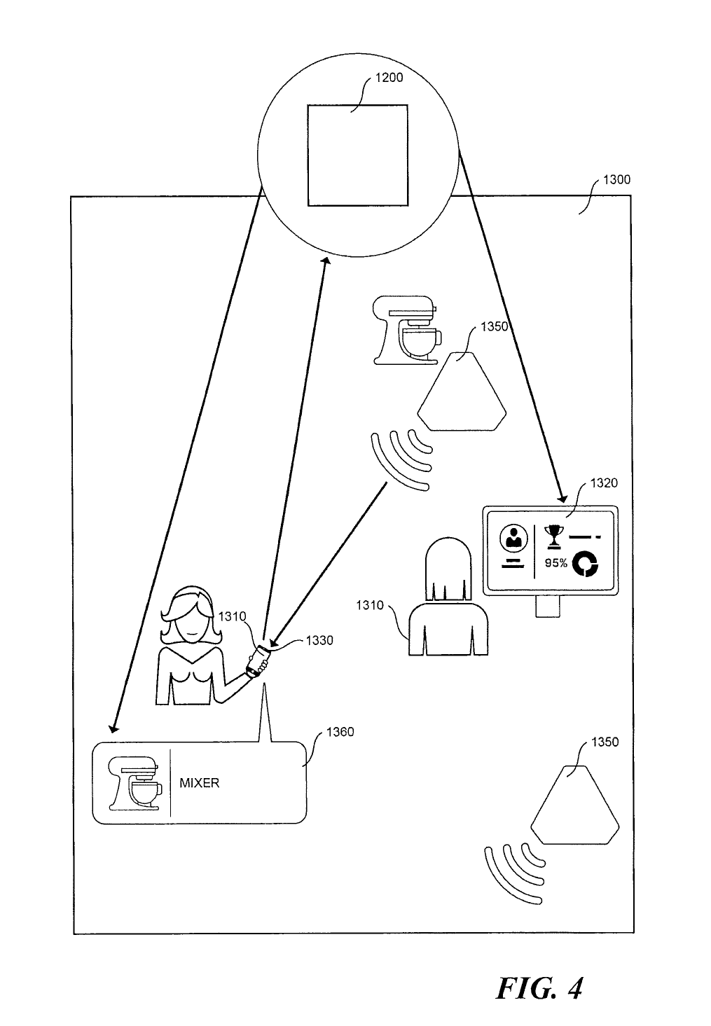

FIG. 4 illustrates an example of identifying a recipient's entrance to the Indoor Space 1300 with Beacons 1350 so that the Indoor Space Assistant 1310 can have insight into data about recipient's presence and activity displayed on the Onsite Back-End Application 1320 installed in the Indoor Space 1300. The Indoor Space Assistant 1310 may be represented by a person or any form of artificial intelligence. Right after the recipient, equipped with the Dedicated Application 1340 receiving Beacon 1350 signals, moves past the first Beacon 1350 with the location-based incentive 1360 e.g. “welcome Beacon”, the Back-Office System 1200 gets information from the Dedicated Application 1340 about his/her presence and forwards this data to its Onsite Back-End Application 1320. The Onsite Back-End Application 1320 responds to this information by instantly displaying on its screen the recipients' details as well as their responses to the location-based incentives 1360 triggered near Beacons 1350 during their current visit. The Onsite Back-End Application 1320 may display all data which may be relevant for providing personal assistance in the Indoor Space 1300. The Onsite Back-End Application 1320 operated by the Indoor Space Assistants 1310 lets them track the real-time list of recipients being indoors and having Portable Devices 1330 equipped with the Dedicated Application 1340.

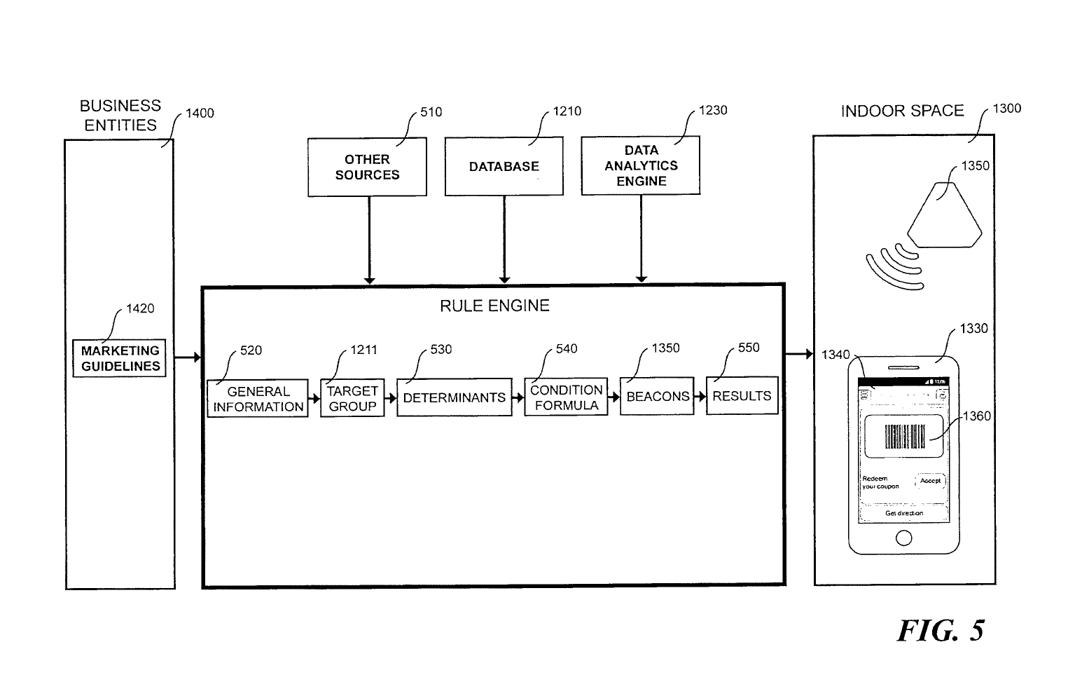

FIG. 5 shows an example of defining the location-based incentives 1360 triggered by Beacons 1350 and targeting Indoor Space 1300. In more detail, the Rule Engine 1240 creates the location-based incentives 1360 following Marketing Guidelines 1420 pre-defined by the Business Entities 1400. Marketing Guidelines 1420 comprise the assumptions for the location-based incentives 1360. An example of the Marketing Guidelines 1420 may include:

The location-based incentive should be launched in defined time frame X, should target recipients who checked-in at least Y times in specific indoor locations Z, made at least one purchase and should get combination of many Results 310, e.g.: points and personalized message”.

Still referring to FIG. 5, to create the location-based incentives 1360, the Rule Engine 1240 uses not only unlimited data stored in the Database 1210. It may also use the data and forecasts performed by the Data Analytics Engine 1230 or any data from Other Sources 510. Creation of the location-based incentives 1360 in the Rule Engine 1240 may include following actions:
creation of the General Information 520, including: date of its execution (start/end date), active hours, fixed schedule, its description, active/inactive location(s) in the Indoor Space 1300 of the involved Business Entities 1400,
setting Determinants 530 that is singular or plural events which initiate the location-based incentives 1360 in the Indoor Space 1300 near Beacons 1350, including: a purchase, a Beacon, a coupon, a check-in, a gamification event, and other events, creation of specific categories of Beacons 1350,
setting Target Group 1211 eligible to receive and participate in the location-based incentives 1360,
setting Condition Formula 540 which must be fulfilled to run Results 310 of the location-based incentives 1360; e.g. the Condition Formula that the transaction value exceeds $10 verifies whether transaction value is greater than $10,
setting singular or plural Results 310 including: benefits, privileges; given when the Condition Formula 540 of the location-based incentives 1360 is fulfilled.

The creation of location-based incentives 1360 may also comprise other actions:
setting priority rules if many location-based incentives 1360 may be displayed at the time when the recipient's Dedicated Application 1340 installed on Portable Device 1330 detects Beacons 1350,
setting limits of the location-based incentives 1360 with similar Determinants 530 Results 310 displayed nearby Beacons 1350 to determine how they should be pushed by the Rule Engine 1240,
setting how to display location-based incentives 1360 on the Dedicated Application 1340 if for the given Beacon category in the same distance there is more than one location-based incentive 1360 for the recipient,
setting how many times one recipient can get the same location-based incentives 1360 within a specified time interval.

Still referring to FIG. 5, the creation of the location-based incentives 1360 in the Rule Engine 1240 do not have to include all of the described actions and other actions unmentioned herein may occur.

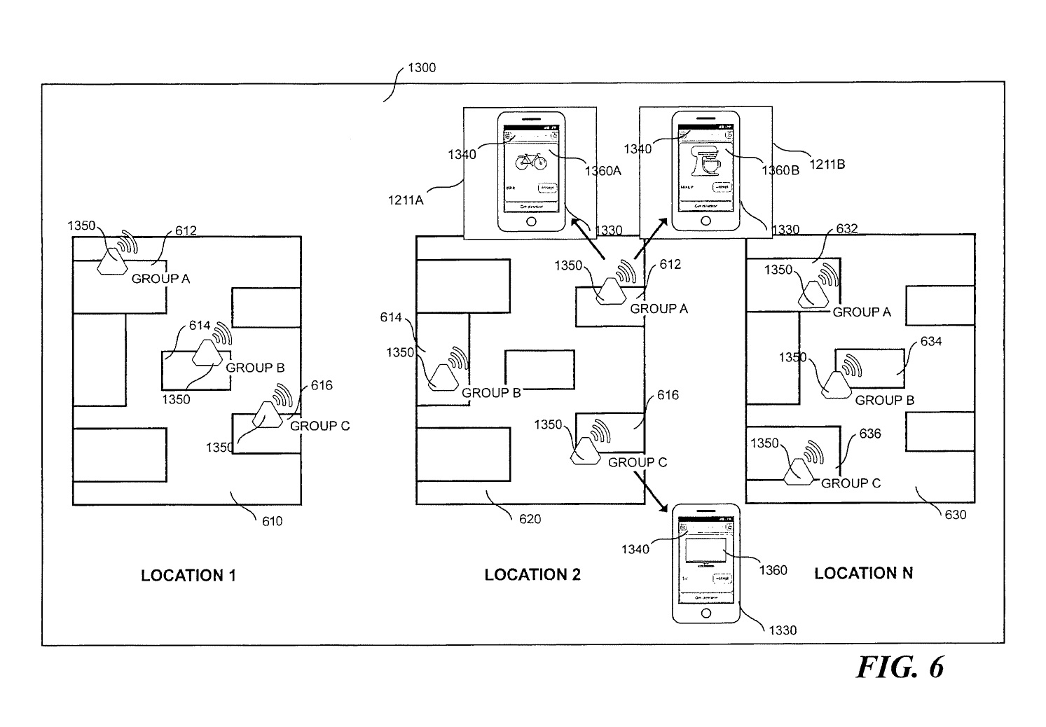

Referring now to FIG. 6, in one embodiment, Beacons 1350 are triggers for broadcasting the location-based incentives 1360 in the Indoor Space 1300. The Indoor Space 1300 may include many locations, such as Location 1 610, Location 2 620 and Location N 630. Depending on particular precision marketing strategy indoors, linked e.g. to a given product or individual spots within a location of the Indoor Space 1300 (e.g. the entrance), different Beacon categories may be created, such as Category A 612, Category B 614, and Category C 616. The same Beacon categories may be common for different locations (e.g. Location 1 610 and Location 2 620) or/and new categories may be created for different locations (e.g. Location N 630 has distinct Beacon Categories: Category A 632, Category B 634 and Category C 636). Thus, in certain embodiments, the location-based incentives 1360 do not need to be manually assigned to each of the individual Beacons 1350. Particular location-based incentives 1360 are assigned to Beacon categories, nevertheless, they may further vary within one category depending on e.g. the Target Group 1211. Accordingly, even though location-based incentives 1360A and 1360B are triggered by Beacon 1350 of the same category, their content differs and is personalized to match recipients' Target Groups 1211A and 1211B and their Preferences.

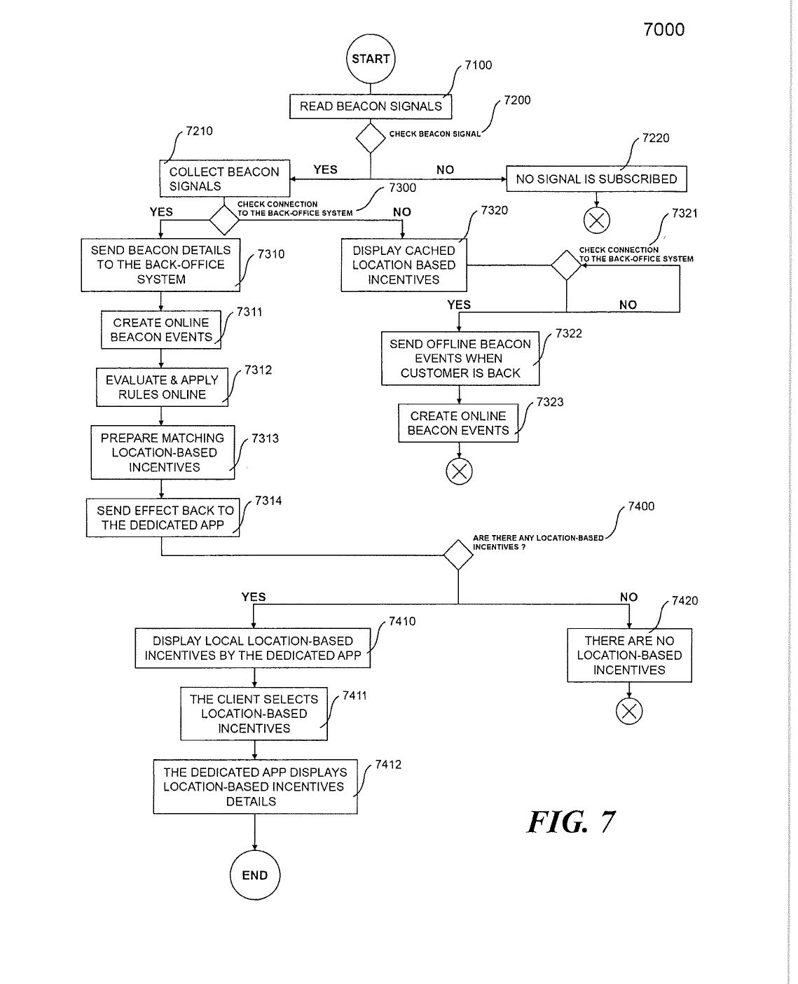

FIG. 7 is a flow diagram illustrating the method 7000 for managing location-based incentives in the Indoor Space, at the time when the Dedicated Application installed on recipient's Portable Device detects Beacons.

At stage 7100 the Portable Device reads Beacon signals. The Portable Device responds to the signal from Beacons installed in the Indoor Space only when the Portable Device has the Bluetooth signal turned on.

At stage 7200 the Dedicated Application installed on the Portable Device verifies whether it subscribes Beacons signals in the Indoor Space. If it is determined that Beacon signals are not recognized (or subscribed), method 7000 may end at stage 7220; otherwise method 7000 may proceed to stage 7210 at which the Dedicated Application collects all recognized (or subscribed) Beacon signals.

Further, at stage 7300 the Dedicated Application checks a connection to the Back-Office System. If it is determined that the Dedicated Application is connected to the Back-Office System, method 7000 may proceed to stage 7310; otherwise, method 7000 may proceed to stage 7320 at which time, since there in no connection to the Back-Office System, the Dedicated Application displays only cached location-based incentives which were downloaded earlier from the Back-Office System and are stored locally on the Dedicated Application.

Further, at stage 7321 the Dedicated Application checks whether the connection to the Back-Office System is back. If it is determined that connection is not back, method 7000 may end at stage 7321 with the Dedicated Application repeatedly checking whether there is a connection; otherwise method 7000 may proceed to stage 7322 at which time the Dedicated Application sends to the Back-Office System all offline Beacon events associated with the detected Beacons in the Indoor Space to evaluate and process them in the Rule Engine. Depending on the Sale Systems, the offline Beacon events may include: purchase value, purchased items, check-in, survey fulfillment, coupon redemption, recipient's presence and activity in the Indoor Space, which happened while connection to the Back-Office System was lost.

At stage 7323 the Rule Engine applies Rules for the offline Beacon events. The Rules may be triggered by any set of detected Beacons and may apply singular or plural Results comprising: benefits, privileges to Target Group, e.g. points, message, a new attribute, new qualifying rule, a discount, a voucher, etc. There is no limitation of what should be the Results. The Results may be assigned to the recipients either real-time, postponed or in mixed combination.

At stage 7310, the Dedicated Application connected to the Back-Office System sends to the Back-Office System all detected Beacons parameters and method 7000 may proceed to stage 7311 at which time the Rule Engine prepares online Beacon events associated with the detected Beacons in the Indoor Space. Depending on the Sale Systems, the online Beacon events may include: purchase value, purchased items, check-in, survey fulfillment, coupon redemption, recipient's presence and activity in the Indoor Space which happened while the connection to the Back-Office System was maintained.

At stage 7312 the Rule Engine applies Rules for the online Beacon events. The Rules may be triggered by any set of detected Beacons and may apply singular or plural Results comprising: benefits, privileges to Target Group, e.g. points, message, a new attribute, new qualifying rule, a discount, a voucher, etc. There is no limitation of what should be the Results. The Results may be assigned to the recipients either real-time, postponed or in mixed combination.

At stage 7313 the Rule Engine prepares location-based incentives matching the recipients' Preferences, Target Group and detected Beacons and method 7000 may proceed to stage 7314 at which time the Back-Office System sends back matching incentives to the Dedicated Application.

At stage 7400, the Dedicated Application checks whether detected Beacons should trigger any location-based incentives. If it is determined that no location-based incentives are assigned to detected Beacons, method 7000 may proceed to stage 7420; otherwise, if at least one location-based incentive is assigned to detected Beacons, method 7000 may proceed to stage 7410 at which time the Dedicated Application, even if it is not turned on, displays all local push notifications for matching location-based incentives in the Indoor Space. If there are more than one location-based incentives that match detected Beacons in the Indoor Space they are displayed on the list and the closest is displayed on the Dedicated Application at the top.

At stage 7411 the recipient may browse and select all location-based incentives, and method 7000 may proceed to stage 7412 at which time the Dedicated Application displays details of the chosen ones.

While various stages of the method 7000 are illustrated and described in a particular order, it should be understood that these stages do not have to be performed in this order. Rather, various stages may be handled in a different order or simultaneously, and stages may also be added or omitted unless otherwise stated.

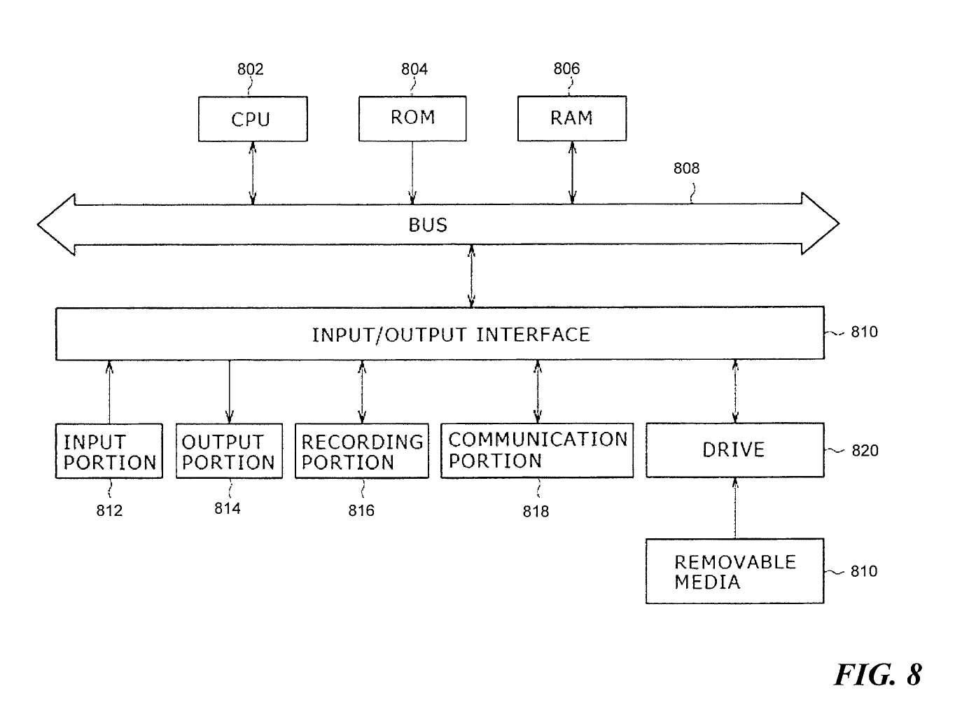

FIG. 8 is a block diagram showing an example of a hardware configuration of a computer that can be configured to perform functions of any one or a combination of the Portable Device 1330, the Back Office System 1200, and the Sales System 1410.

As illustrated in FIG. 8 the computer includes a central processing unit (CPU) 802, read only memory (ROM) 804, and a random access memory (RAM) 806 interconnected to each other via one or more buses 808. The one or more buses 808 are further connected with an input-output interface 810. The input-output interface 810 is connected with an input portion 812 formed by a keyboard, a mouse, a microphone, remote controller, touch screen, etc. The input-output interface 810 is also connected an output portion 814 formed by an audio interface, video interface, display, speaker and the like; a recording portion 816 formed by a hard disk, a non-volatile memory or other non-transitory computer readable storage medium; a communication portion 818 formed by a network interface, modem, USB interface, fire wire interface, etc.; and a drive 820 for driving removable media 822 such as a magnetic disk, an optical disk, a magneto-optical disk, a semiconductor memory, etc.

According to one embodiment, the CPU 802 loads a program (e.g., the dedicated application) stored in the recording portion 816 into the RAM 806 via the input-output interface 810 and the bus 808, and then executes a program configured to provide the functionality of the one or combination of the Portable Device 1330, the Back Office System 1200, and the Sales System 1410.

The hardware description above, exemplified by any one of the structure examples shown in FIG. 8, constitutes or includes specialized corresponding structure that is programmed or configured to perform all or part of the algorithm shown, for example, in FIG. 7. For example, the algorithm shown in FIG. 7 may be performed by the circuitry included in a plurality of the device shown in FIG. 8.

Obviously, numerous modifications and variations are possible in light of the above teachings. It is therefore to be understood that within the scope of the appended claims, the embodiments of the present disclosure may be practiced otherwise than as specifically described herein.

Thus, the foregoing discussion discloses and describes merely exemplary embodiments of the present disclosure. As will be understood by those skilled in the art, the present disclosure may be embodied in other specific foil is without departing from the spirit or essential characteristics thereof. Accordingly, the present disclosure is intended to be illustrative, but not limiting of the scope of the present disclosure, as well as other claims. The disclosure, including any readily discernible variants of the teachings herein, defines, in part, the scope of the foregoing claim terminology such that no inventive subject matter is dedicated to the public.

What is claimed is:

1. A method for content distribution in an indoor space and surrounding area covered by beacon signals, the method comprising:
setting general data of the content;
setting at least one location in the indoor space, including one or a combination of active/inactive locations and other relevant information available in a system;
assigning beacons that trigger the content in the indoor space;
receiving by the system, from a portable device via a first communication channel, beacon information that is received from a beacon by the portable device via a second communication channel, the first communication channel being different from the second communication channel;
setting a singular event or plural events which initiates the content in the indoor space;
setting a condition formula for the content which must be fulfilled to qualify for the content,
setting singular or plural results of the content that are provided when the condition formula is fulfilled;
selecting, by circuitry of the system, at least one of the content based on one or a combination of the set general data of the content, the set at least one location in the indoor space, the assigned beacons that trigger the content, the set condition formula, and the set singular or plural results; and
transmitting, by the circuitry via the first communication channel, the selected at least one of the content to the portable device.
